(19) United States
(12) Patent Application Publication
(10) Pub. No.: US 2026/0362113 A1
(43) Pub. Date: Nov. 12, 2026

(54) METHODS AND APPARATUSES FOR MODULAR NON-ACCESS STRATUM DESIGN

(71) Applicant: InterDigital Patent Holdings, Inc., Wilmington, DE (US)

(72) Inventors: Anuj Sethi, Ottawa (CA); Ulises Olvera-Hernandez, Saint-Lazare (CA); Michael Starsinic, Newtown, PA (US); Samir Ferdi, Kirkland (CA); Jung Je Son, Warrington, PA (US); Guanzhou Wang, Brossard (CA); Taimoor Abbas, Sainte-Julie (CA)

(73) Assignee: InterDigital Patent Holdings, Inc., Wilmington, DE (US)

(21) Appl. No.: 19/202,763

(22) Filed: May 8, 2025

(51) Int. Cl. H04W 8/08; H04W 8/22

(52) U.S. Cl. CPC H04W 8/08; H04W 8/22

(57) ABSTRACT

A wireless transmit/receive unit (WTRU) enables one or more Non-Access Stratum (NAS) modules based on a WTRU configuration and one or more WTRU capabilities. The WTRU transmits an activation request message, including a WTRU identifier (ID) for the WTRU, the one or more WTRU capabilities and a list of the one or more NAS modules enabled in the WTRU. The WTRU downloads at least one additional NAS module, and receives an activation response message, including information indicating that activation of the one or more NAS modules is successful, and that activation of the at least one additional NAS module is successful. The WTRU transmits, based on the activation of the one or more NAS modules, one or more messages using the one or more NAS modules, or the at least one additional NAS module.

### BACKGROUND

The Access Stratum (AS) protocol refers to a layer of one or more communication protocols used between the User Equipment (UE) or wireless transmit/receive unit (WTRU) and the radio access network (RAN). The Non-Access Stratum (NAS) protocol refers to a layer of communication protocols used between the UE or WTRU and the Access and Mobility Management Function (AMF) located in the Core Network (CN) in the Fifth Generation (5G) core (5GC). The NAS protocol operates above the AS and plays a key role in managing signaling for mobility and session management.

Different mobile network functions (NFs) are based on the NAS protocol. The NAS protocol ensures efficient and secure communication between the WTRU and the 5GC by supporting features and functions expected in 5G networks.

### SUMMARY

Methods and apparatuses for modular non-access stratum design are disclosed herein. A wireless transmit/receive unit (WTRU) enables one or more Non-Access Stratum (NAS) modules based on a WTRU configuration and one or more WTRU capabilities. The WTRU transmits an activation request message, including a WTRU identifier (ID) for the WTRU, the one or more WTRU capabilities and a list of the one or more NAS modules enabled in the WTRU. Additionally or alternatively, a base station receives activation request message. Additionally or alternatively, the base station transmits, to a network function (NF), a check WTRU capability request message including the WTRU ID for the WTRU, the one or more WTRU capabilities, and the list of the one or more NAS modules enabled in the WTRU. Additionally or alternatively, the base station receives, from the NF, a check WTRU capability response message including the WTRU ID for the WTRU, a list of additional NAS modules to download, and a correlation ID.

Further, the WTRU downloads at least one additional NAS module. Also, the WTRU receives an activation response message, including information indicating that activation of the one or more NAS modules is successful, and that activation of the at least one additional NAS module is successful. Additionally or alternatively, the activation response message is transmitted from the base station. Moreover, the WTRU transmits, based on the activation of the one or more NAS modules, one or more messages using the one or more NAS modules, or the at least one additional NAS module. Additionally or alternatively, the base station receives the one or more messages using the one or more NAS modules, or the at least one additional NAS module.

Additionally or alternatively, the one or more messages are transmitted using a service based interface (SBI). Additionally or alternatively, the one or more NAS modules are enabled based on one or more of: graphical user interface (GUI) inputs; previous communication with core network functions; configuration information provided by an application function; configuration information provided by an operator or an administrator of the WTRU via over-the-top (OTT) means; the WTRU configuration, wherein the WTRU configuration is stored; or the one or more WTRU capabilities.

Additionally or alternatively, the one or more NAS modules include one or more of: a registration management (RM) module, a mobility management (MM) module, a session management (SM) module, or a location services (LOC) module. Additionally or alternatively, the WTRU downloads the one or more NAS modules from a configuration management function (CFMF), transmits the activation request message to a central routing function (CRF), and receives the activation response message from the CRF.

Additionally or alternatively, the WTRU communicates with one or more of: a Sixth Generation (6G) mobility management (6GMM) function, a 6G session management (6GSM) function, or another 6G network function (NF). Additionally or alternatively, the base station is a CRF. Additionally or alternatively, the base station communicates with one or more of: a 6GMM function, a 6GSM function, or another 6G NF.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example simplified Fifth Generation (5G) system architecture;

FIG. 3 is a communications stack diagram illustrating an example of the control plane stack between a WTRU and an Access and Mobility Management Function (AMF);

FIG. 4 is a system diagram illustrating an example of simplified next generation network architecture with a RAN as a Service Based Interface (SBI) gateway;

FIG. 5 is a modular diagram illustrating an example of a modular Non-Access Stratum (NAS) design with independent and orthogonal functional modules;

FIG. 6 is a signaling diagram illustrating an example of an activation and configuration of NAS modules;

FIG. 7 is a signaling diagram illustrating an example of a reconfiguration of NAS modules; and

FIG. 8 is a signaling diagram illustrating an example of network initiated deactivation of NAS modules.

### DETAILED DESCRIPTION

Examples and embodiments provided herein may use the following abbreviations and acronyms.
6GS 6G System
6GMM 6G Mobility Management
6GSM 6G Session Management
6GS 6G System
5GS 5G System
6GC 6G Core
5GC 5G Core
AF Application Function
AMF Access and Mobility Management Function
CM Connection Management
CC Call Control
CRF Central Routing Function
CFM Configuration Management
DNN Data Network Name
LOC Location Services
MIB Master Information Block
MM Mobility Management
NEF Network Exposure Function
NF Network Function
NIRR Network Initiated Registration Request
NIRF Network Initiated Request Management Function
NWDAF Network Data Analytics Function
Ng-gNB Next Generation of gNB (6GS)
PDU Protocol Data Unit
RM Registration Management
SIB System Information Block
SMF Session Management Function
SM Session Management
UDM Unified Data Management
UPF User Plane Function

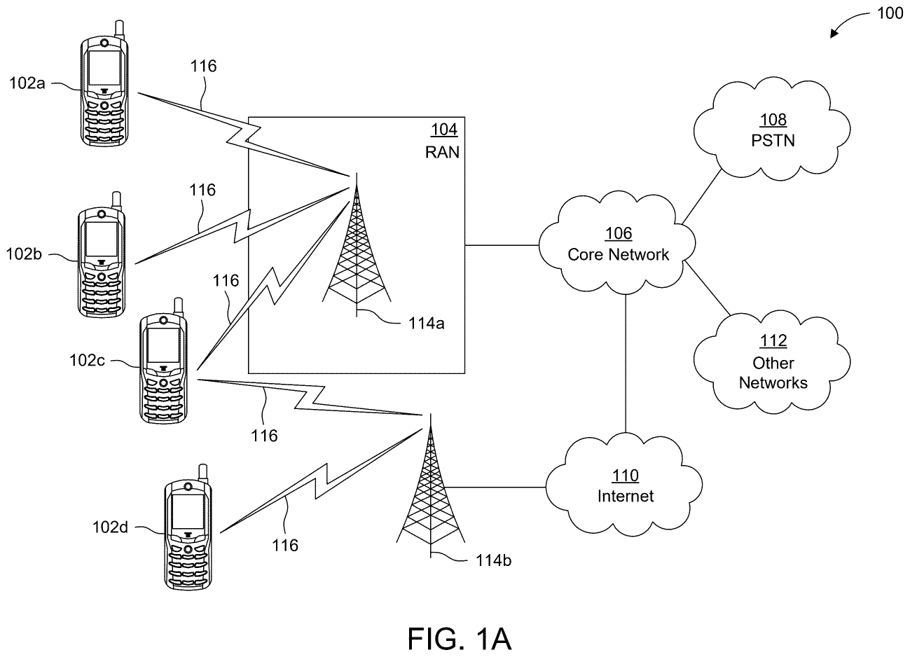

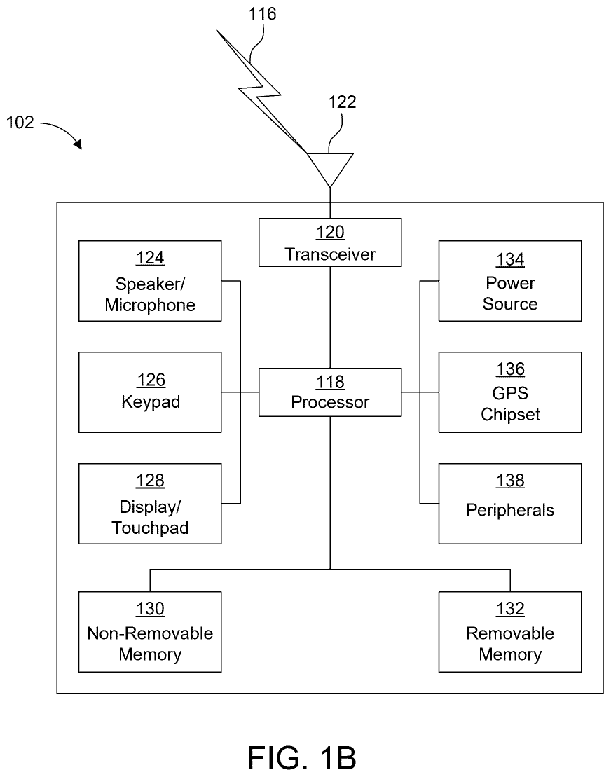

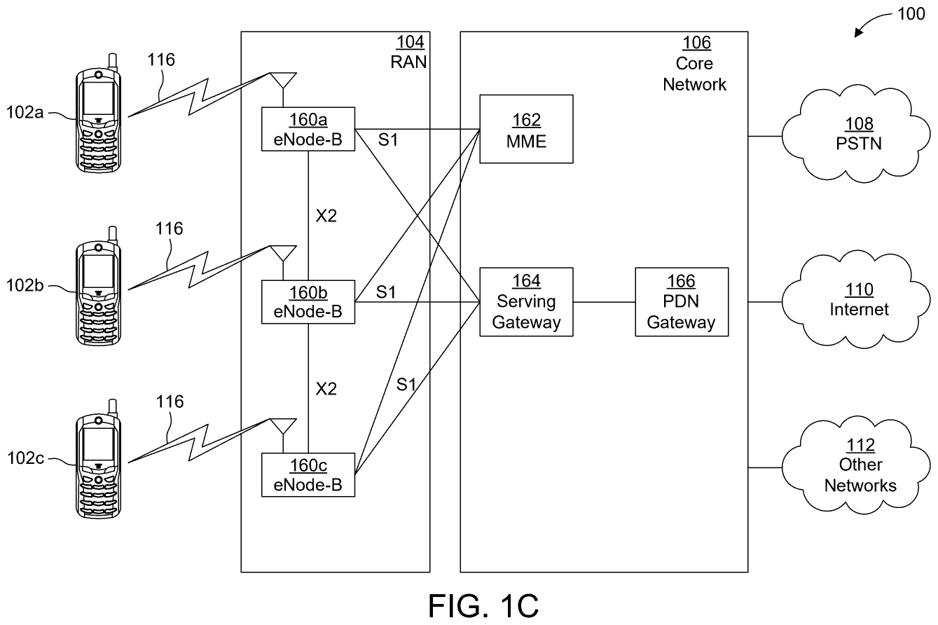

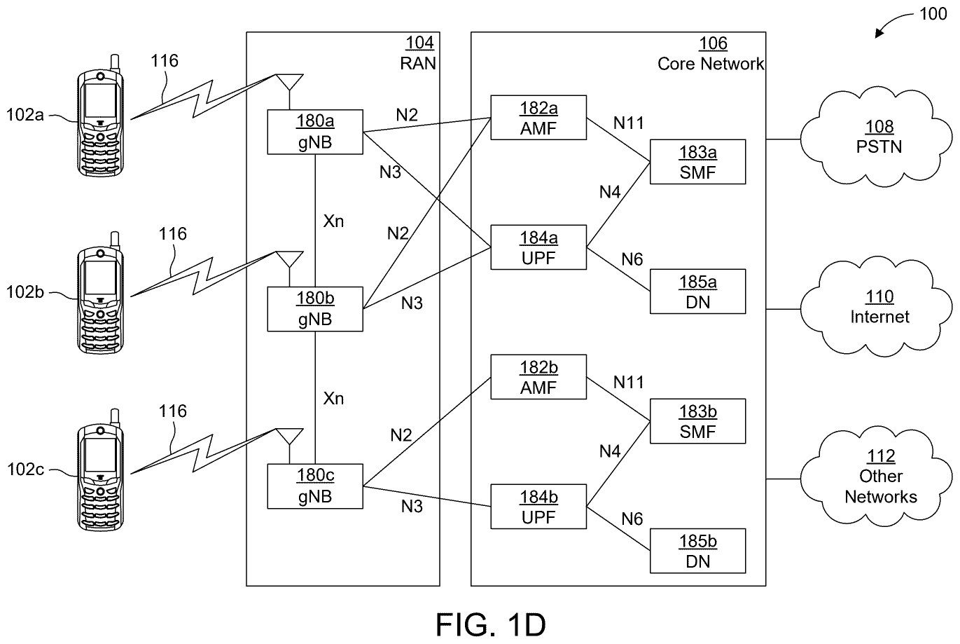

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

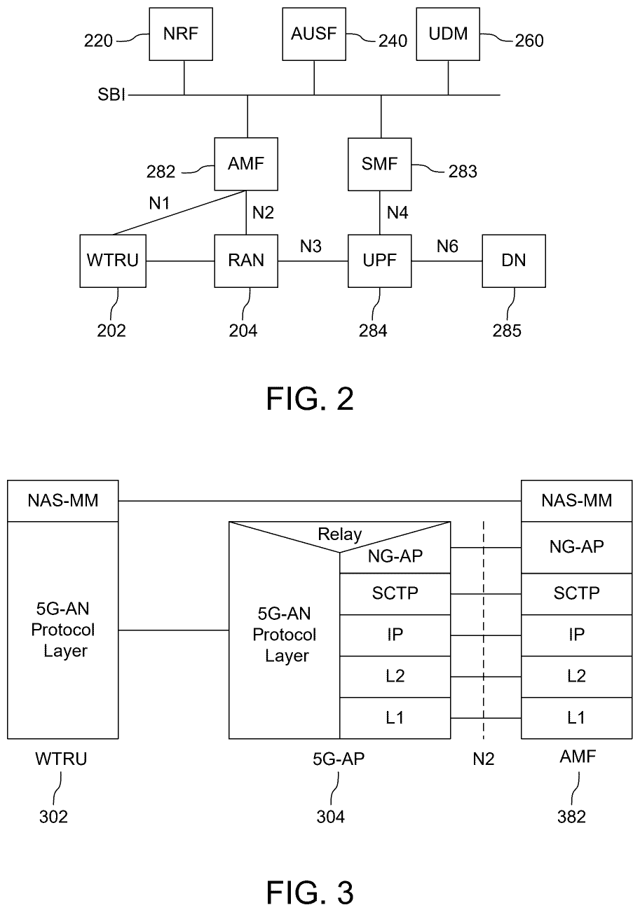

FIG. 2 is a system diagram illustrating an example simplified Fifth Generation (5G) system architecture. In an example shown in FIG. 2, only a subset of the network functions (NFs) in the 5G core (5GC) are represented. The NFs, for example, AMF 282, SMF 283, UDM 260, communicate with each other using Service Based Interface (SBI), using protocols such as hypertext transfer protocol (HTTP). The goal of the Service Base Architecture (SBA) is to enable NFs to expose services, for example, using application programming interfaces (APIs) following the principles of representational state transfer (REST) (RESTful APIs), to other NFs, for the system to provide the desired functionality. For example, the NR repository function (NRF) 220 and the authentication server function (AUSF) 240 communicate with other NFs using SBI.

Note that the current 5G System Architecture does not offer a full Service Based environment. While most interaction may be supported using Service Based Interfaces, there are some interfaces that still remain exclusively as point-to-point interfaces between two entities. These interfaces are shown as (Nx) in FIG. 1 and as described below, they are different from SBI.

WTRU 202 communicates with AMF 282 over N1 using a NAS (Non-Access Stratum) protocol. Control plane messaging between the WTRU and other NFs (for example, SMF 283) is done using NAS transport encapsulation mechanism provided by AMF for the NFs. These point-to-point interfaces are also used by RAN 204, UPF 284 and DN 285.

FIG. 3 is a communications stack diagram illustrating an example of the control plane stack between a WTRU and an AMF. As shown in an example in FIG. 3, a RAN, such as a 5G-access node (AN) 304 communicates with AMF 382 over N2 using a next generation application protocol (NGAP). Control plane messaging between WTRU 302 and RAN 304 (Access Stratum (AS)) is done using radio resource control (RRC) (at the top of the 5G-AN 304 Protocol layers) which is used to transport NAS messages received or sent by RAN 304 over N2.

Examples are provided in the following of the evolution outlook of the next generation network, including beyond 5G. The Next Generation Network architecture, which is expected to extend SBA concepts to the RAN, to simplify the network architecture while taking advantage of cloud native and micro-services technology to enhance architecture capabilities such as scalability, elasticity, and open interfaces.

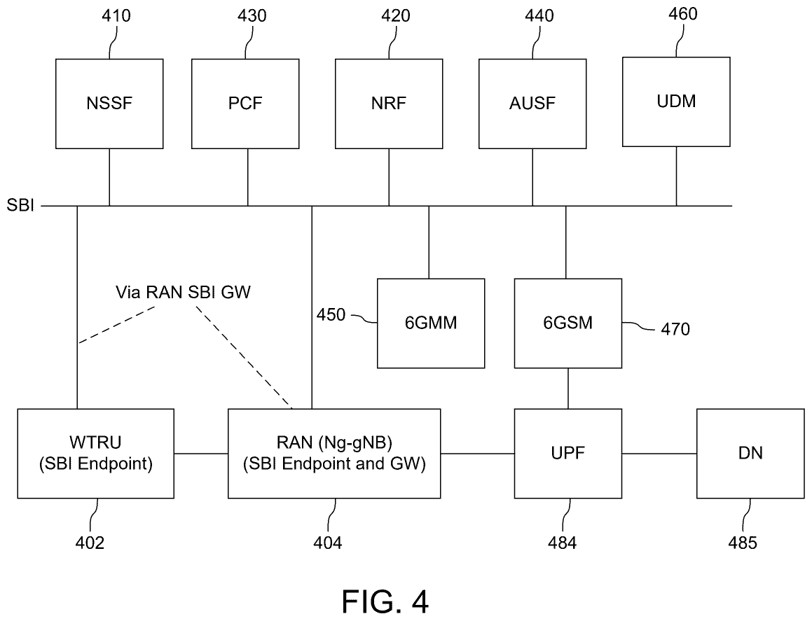

FIG. 4 is a system diagram illustrating an example of simplified next generation network architecture with a RAN as an SBI gateway. As shown in an example in FIG. 4, new architecture proposals are emerging with the possibility to extend the SBI framework beyond the 5GC NFs. For example, a WTRU 402 may use an evolved NAS mechanism to exchange NAS application messages directly with one or more NFs. As an example, an SBI compliant WTRU 402 may establish an NAS application layer communication directly with an NF (for example, SMF) without going through AMF (in other words, enhancing the N1 reference point to offer NAS application services over an SBI).

In another trend, the next generation network is touted as bringing about the so called “connected intelligence” where intelligent networks using artificial intelligence machine learning (AIML) technology will be able to connect a multitude of “intelligent” things. With huge amount of data collection from a multitude of devices (for example, sensors, Ambient IoT) and with the added high flexibility and adaptability of AIML enabled functionalities, the system will pave the way for new advanced applications such as extended reality (XR)/Metaverse.

As shown in an example in FIG. 4, the RAN node 404, which may also be called an Ng-gNB, supports SBI towards the next generation Core Network (called 6GC herein). The Ng-gNB 404 invokes directly the services needed according to the procedure being performed with the WTRU 402. The existing N2 interface between the gNB and AMF in the 5G architecture is now replaced with the SBI interface from the Ng-gNB 404 to the 6GC (N2 interface from the 5GS), wherein Ng-gNB 404 could invoke services provided by the 6GC over the SBI interface.

Once the WTRU 402 is successfully identified and authenticated, the Ng-gNB 404 can invoke the services provided by the 6G NFs for example for registration and mobility management (6GMM) 450, session management (establishment, modification and release of PDU sessions) via 6G session management (6GSM) function 470.

The Ng-gNB 404 invokes the service of a 6G Mobility Management (6GMM) function 450 for access control or mobility updates of the WTRU 402. The Ng-gNB 402 invokes the 6GSM function 470 for session management service. The 6GSM function 470 is an evolved version of the 5G SMF to support direct interaction with the Ng-gNB 404 for actions such as user plane resource allocation, AN-CN tunnel establishment, and the like. Direct communication between the Ng-gNB 404 and 6GSM function 470 allows for a reduction of signaling overhead due to messaging with one or more intermediate NFs (for example, an AMF) as compared to 5G. Accordingly, SBI may be used not only to communicate with the network slice selection function (NSSF) 410, the policy control function (PCF) 430, the NRF 420, the AUSF 440, and the UDM 460, but also the UPF 484 and DN 485.

Examples are provided in the following of the NAS protocol in mobile wireless networks. The NAS protocol refers to a layer of communication protocols used between the UE or WTRU and the AMF located in the CN in the 5G core. The NAS protocol operates above the AS and plays a key role in managing signaling for mobility and session management.

Different mobile network functions are based on the NAS protocol; examples of mobile network functions based on the NAS protocol are described hereafter. A first function based on the NAS protocol is Mobility Management (MM). The NAS protocol enables to manage location updates as the WTRU moves between tracking areas (TAs) and includes procedures like initial registration, deregistration, and connection management.

A second function based on the NAS protocol is Session Management (SM). The NAS protocol enables to establish, modify, and releases Protocol Data Unit (PDU) sessions for data transmission and support Quality of Service (QoS) management for applications.

A third function based on the NAS protocol is security management. The NAS protocol enables to provide mutual authentication between the WTRU and the Core Network (CN) network and facilitate encryption and integrity protection for NAS messages.

A fourth function based on the NAS protocol is paging handling and coordination. The NAS protocol enables re-establishing communications with the WTRU when in idle mode.

A fifth function based on the NAS protocol is support for 5G system features. The NAS protocol enables slicing support, allowing the WTRU to connect to specific network slices based on service requirements, and enables managing dual connectivity and mobility across heterogeneous networks.

It can be appreciated that in 5G systems, the NAS protocol only offers limited support for data collection and data collection session triggering or management, for example, when collecting positioning measurements. The NAS protocol ensures efficient and secure communication between the WTRU and the 5GC by supporting features and functions expected in 5G networks. Examples of supported functions include secure and encrypted communications, mobility support, session management, scalability (for example, large number of devices), QoS differentiation, and so forth

The NAS protocol may be extended to the beyond 5G networks i.e. 6G mobile wireless system with some modifications and enhancements on the WTRU side as well as on the 6G core network side.

Examples of PDU Session Establishment are provided herein. The 5GC supports a PDU Connectivity Service, in other words, a service that provides exchange of PDUs (Protocol Data Units) between a WTRU and a data network identified by a DNN (Data Network Name). The PDU Connectivity Service is supported via PDU Sessions that are established upon request from the WTRU between the WTRU and 5GC. PDU Sessions are established (upon WTRU request), modified (upon WTRU and 5GC request) and released (upon WTRU and 5GC request) using NAS SM signaling exchanged over N1 between the WTRU and the SMF. Further details regarding Session Management are provided in 3GPP TS 23.501, section 5.6. The contents of 3GPP TS 23.501 are incorporated by reference herein as if set forth in their entirety.

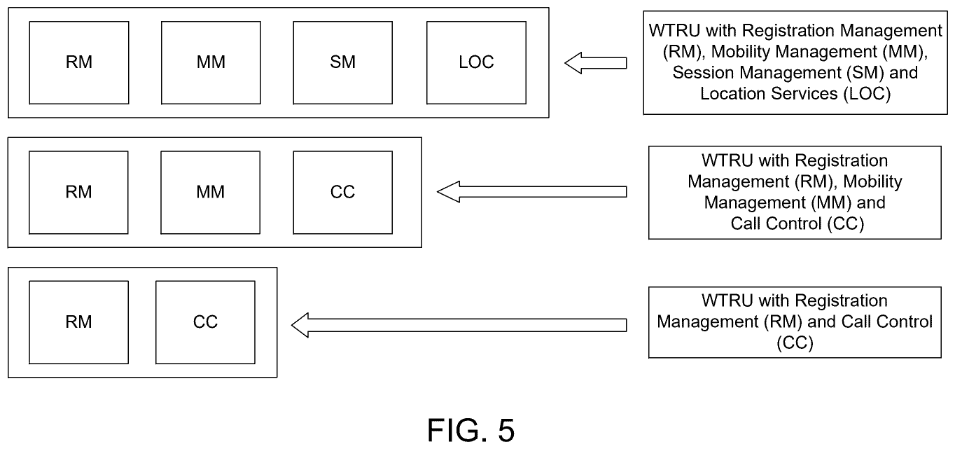

FIG. 5 is a modular diagram illustrating an example of a modular NAS design with independent and orthogonal functional modules. Further, additional functional modules can be added in a similar manner as required. These NAS modules implement functionality independently from each other, with minimal or no interdependency, and can be supported in the devices as and when required. For example, a basic voice device with no mobility requirement could have registration management (RM) and call control (CC) as the NAS modules; and similarly a device which needs mobility, location and data services could have RM/MM/SM/location services (LOC) NAS modules. This approach of modular NAS functional modules offers various advantages such as flexibility and extensibility, scalability, reusability and maintainability.

In examples provided herein a NAS module may be a set of steps, or may be a software routine executed by a processor of a WTRU, base station, or other network node. Additionally or alternatively, the NAS module may be a logical entity at a layer of a protocol stack of the WTRU, base station, or other network node.

In 5G architecture, the AMF is the single-entry point for WTRUs'NAS signaling for example, mobility management, session management, policy configuration, location services, authentication and authorization and so forth This centralized approach has certain disadvantages, for example, a single point of failure, redundant signaling due to systematic involvement of AMF in WTRU exchanges with other NFs (for example, SMF, PCF), signaling delay in case of congestion or overload at AMF (latency issues), AMF could become a bottleneck in supporting deployment with large number of devices, and so forth.

The current 5G architecture mandates that the WTRUs implement full 5G protocol stack capabilities statically with interdependence, regardless of their dynamic usage of the functionalities, such as, for example voice services only, data only, fixed wireless access (FWA), low cost IoT devices, positioning services only, satellite access and so forth. In other words, the NAS functionality on the WTRU presents a “vertical integration” of functional components even though the WTRU may use these functional components occasionally or not at all. This static implementation of the complete 5G protocol stack leads to higher power consumption, unnecessary complexity and increased cost, and does not take into consideration the dynamic operational needs of the WTRU. For example, a WTRU which wants to only operate as a voice only device for a certain period, does not need to support other protocol stack modules for example, location services, sensing or compute, and so forth. In another example, WTRUs operating as stationary IoT devices could have a lightweight MM module which support registration functionality with no support for mobility.

This static implementation of the full protocol stack leads to unnecessary signaling overhead, data handling, higher power consumption, increased hardware requirements (for example, on the WTRU and AMF side). Current system architecture for NAS communications may hinder the system ability to scale properly in the future due to the excess signaling and tight coupling around AMF during any NAS procedure.

Going forward in the beyond 5G networks, embodiments and examples provided herein address the above-described problem and find solutions to the following: how to enhance NAS based communications (for example, a NAS protocol stack) so it would be easier to customize, scale and integrate new functionalities for different types of devices and services.

5G network architecture evolution may enable new capabilities, both in the WTRU and in the network. Some of the existing procedures may be enhanced or redefined to enable the next generation of mobile communication systems.

Embodiments and examples herein provide a new approach to the NAS modular design. The modular NAS comprises NAS functional modules, for example, RM, MM, SM and so forth, that are independent and orthogonal. These NAS modules implement independent functionality from each other, with minimal or no interdependency, and can be supported in the devices as and when required. For example, a basic voice device with no mobility requirement could have (for example, activate selectively) RM and CC as the NAS modules. In another example, a device which needs mobility, location and data services could have (for example, activate selectively) RM/MM/SM/LOC NAS modules. This approach of modular NAS functional modules offers various advantages such as flexibility and extensibility, scalability, reusability and maintainability. Additionally, embodiments and examples herein provide how these new WTRUs, which will be implementing the modular NAS approach, interact with the next generation of wireless networks (for example, 6G networks) and corresponding procedures, such as, activation, reactivation, reconfiguration and discovery of the network functions corresponding to enabled NAS modules in the WTRU.

Examples are provided herein of base station, gNB or central routing function (CRF) actions for modular NAS configuration and activation. A new functional block, such as, for example, the CRF could be collocated within the RAN node, implemented as an additional functionality in other network functions, for example, an AMF, or could be implemented as a standalone network function. In an example, a base station, a CRF, or both (base station/CRF) receive an activation request from the WTRU along with the WTRU identifier and an information element containing list of NAS modules enabled in the WTRU.

The base station, CRF, or both, on reception of the Activation message, may check with a configuration management function (CFMF), for example, based on the WTRU capability compared with the list of NAS modules, to determine whether additional NAS modules are required. The CFMF determines, for example, based on the WTRU capabilities and current NAS module list in the WTRU, whether additional NAS modules are required. The CFMF informs the CRF about any additional NAS modules to be downloaded, and it provides download correlation ID for further use. Note that, additionally or alternatively, the CFMF could execute both the NF discovery procedure (via NRF) and the authentication procedure and simply send and activation confirmation to CRF with the additional NAS modules to be downloaded. The CRF temporarily stores the correlation id and the list of NAS modules to be downloaded, to be used during the authentication procedure.

The base station, CRF, or both, on reception of the Activation message, may query the NRF to discover the corresponding NFs to the list of NAS functional modules which have been enabled in the WTRU and provided by the WTRU in the activation message as part of the new information element containing the list of NAS modules. The base station/CRF will trigger the query request/response with the NRF to discover the NFs corresponding to the list of NAS modules, and the base station/CRF would provide the WTRU identifier along with the information element containing the list of NAS modules.

Further, the base station/CRF would create a WTRU context which will contain information, such as, for example, a WTRU identifier, list of NAS modules configured, corresponding NFs, including address information, such as a fully qualified domain name (FQDN)/Internet protocol (IP) Address, and the like.

Also, the base station/CRF might trigger an authentication and authorization (A&A) process to ensure that the WTRU has access to the requested network functions and corresponding functionality. For example, if the list of NAS modules provided by the WTRU has session management (SM) functionality enabled, the base station/CRF may trigger the A&A process between the WTRU and corresponding NF to ensure that the WTRU is an authorized WTRU to access the services provided by the network function, in other words, session management (SM). This A&A process could be the existing mechanism being used in the 5G system, such as secondary authentication involving an external authentication, authorization, and accounting (AAA) server or this A&A process could be a mutual authentication between the WTRU and the corresponding NFs. If the base station/CRF decided to carry out the A&A process the WTRU context which was created in this step, would be updated after the successful A&A procedure. In case the A&A process is not successful the WTRU might be indicated the same, which might result in the requested services being not enabled for the WTRU.

Additionally or alternatively, the base station/CRF determines whether additional NAS modules need to be downloaded, based on the information received from the CFMF in another step. The base station/CRF request from the CFMF the download of NAS modules, by providing the correlation ID and WTRU ID, and possibly a WTRU IP address if the download is to be done via the user plane (UP). The CFMF determines whether the download will happen based on the WTRU's IP address, mobile network operator (MNO) polices and unified data management (UDM) subscription. The CFMF downloads the additional NAS modules for example, via a control plane (CP) NAS DL TRANSPORT message or via the user plane (UP) towards the IP address provided by the CRF in a similar step.

Additionally or alternatively, the base station/CRF sends the Activation response back to the WTRU indicating success. The success indication means the requested NAS functional modules have been accepted by the network and corresponding services are enabled/available for the WTRU to access.

Additionally or alternatively, the base station/CRF, on reception of the reconfiguration required message from the WTRU, will pull the information about the configured NFs from the stored WTRU context and inform all configured NFs about the WTRU unavailability due to reconfiguration of NAS functional modules.

Additionally or alternatively, the base station/CRF will indicate all configured NFs about the WTRU's unavailability due to reconfiguration via WTRU Unavailability Request/Response messages, including WTRU identifier and reconfiguration as the reason for WTRU being unavailable. The NFs, based on their local configuration/implementation, would either discard or buffer the downlink traffic for the WTRU. If an application function or other network function has subscribed to the availability of the WTRU, the NF would indicate unavailability of the WTRU.

Additionally or alternatively, the base station/CRF would indicate the Reconfiguration Confirmed to the WTRU, once it has received response from all configured NFs.

Additionally or alternatively, the base station/CRF, on the reception of the re-activation request message from the WTRU, pulls out the WTRU context information and determine the difference between the newly requested list of NAS modules and already configured NAS modules as per the WTRU stored context. The base station/CRF will determine the difference for the corresponding NFs to the newly requested/reactivated NAS modules, will indicate termination to the NFs which are no longer needed, discover and add new NFs (FQDN/IP Address), and indicate availability back again for the NFs which have no change.

Additionally or alternatively, the base station/CRF will indicate WTRU context termination request/response to the NFs which are no longer needed, the message would carry the WTRU identifier as a parameter.

Additionally or alternatively, the base station/CRF determines to the deactivate WTRU's access to certain services/NFs. The trigger for network-initiated deactivation of NAS functional modules could be based on various factors for example, Policy based (for example, inputs from the predictive analytics, AIML modeling, Energy efficiency, and so forth), WTRU usage based (inactivity or services being not used for a while), subscription (location/time), Network conditions (congestion), input from the AF, and so forth.

Additionally or alternatively, the base station/CRF sends the De-Activation request message to the WTRU along with the list of NAS modules and corresponding network functions which have been removed. In examples, a 6Gxx function, a 6Gyy function, or both have been removed for the WTRU. The base station/CRF would update the WTRU context to reflect this information.

Additionally or alternatively, the base station/CRF, on reception of the De-activation response from the WTRU, indicates about the WTRU context termination to respective NFs which have been removed for the WTRU, including WTRU identifier as a parameter to the message.

Examples are provided herein of WTRU actions for modular NAS configuration and activation. In an example, the WTRU which supports the NAS modular design is powered on. The upper layers, graphical user interface (GUI), or other stored configuration within the WTRU would provide the list of NAS functional modules which are enabled for the WTRU. This configuration could be provided by the application function (AF) via the IP connectivity to the WTRU or this information is configured via over-the-top (OTT) means by the operator or administrator of the WTRU. The WTRU once powered on would try to find a cell, camp on it, and establish the radio connection with the RAN node (base station, such as a gNB, next generation of the gNB, gNB for 6G wireless networks, and so forth). The radio communication between the WTRU and RAN node could have security establishment using existing 5G mechanisms to establish secure RRC layer communication, acting as a secure transport layer to carry upper layer (NAS) messages between the WTRU and RAN node.

Further, the WTRU, on reception of successful activation of the functional blocks (NAS Modules) by the network, will establish communication with the respective NFs. In an example, now the WTRU can communicate with the 6GSM (Session Management), or new set of 6G network functions, for example, 6GXX/6GYY, via the base station/CRF using the SBI based communication.

Additionally or alternatively, during the activation process, the WTRU is usually just enabled to access network functions (NFs). However, the actual selection of the instance of the NF could be carried out in this step, where the selection of the NF entity can be dependent on many factors, for example, local configuration in the CRF, UDM/Subscription information for the WTRU, slice requirements (such as single-network slice selection assistance information (S-NSSAI)), data network name (DNN), requested services (such as, QoS differentiation for devices connected behind the WTRU, voice services, voice over 6G, and so forth), WTRU's location information and network conditions (NF load and availability), and so forth.

Additionally or alternatively, based on the trigger to update the configured NAS modules within the WTRU, for example, to add/remove NAS functional modules, the WTRU sends the Reconfiguration Required along with the WTRU identifier to the base station/CRF. The trigger to update the configuration of the NAS modules within the WTRU could come from various sources for example, from upper layers or GUI, trigger linked with time or location enabling/disabling certain NAS functionalities, the trigger could come from the application function (AF) via the IP connectivity to the WTRU or this information is configured via the OTT means by the operator or administrator of the WTRU.

Additionally or alternatively, the WTRU, on reception of the reconfiguration confirmed message would reconfigure the NAS modules, for example, add/remove NAS modules and trigger the re-activation process with the base station/CRF.

Additionally or alternatively, the WTRU sends the re-activation request to the base station/CRF. In an example, the re-activation message is similar to the activation message, with a difference that re-activation message is sent by the WTRU when it has already been activated with the network before. In other words, the base station/CRF already has WTRU context and list of configured NAS modules and corresponding NFs.

Additionally or alternatively, the WTRU, on reception of the De-Activation request message, reconfigures the NAS modules, removes the NAS Modules corresponding to the list of NAS Modules/NFs provided by the base station/CRF, and locally discards the UL Data/pending data for the removed NAS modules, for example, for xx and yy.

Additionally or alternatively, the WTRU responds to the base station/CRF with the deactivation response including the WTRU identifier and updated list of NAS modules excluding the ones which have been indicated as removed by the network, by the base station/CRF, or by both.

Embodiments and examples provided herein include modular and independent NAS modules. In an example in FIG. 5, the WTRU may comprise dedicated functionality for NAS module Configuration Management (CFM) (not shown in the figure). CFM function may be realized as part of the RM module. The RM module may provide minimal functionality to enable WTRU network access (identification, authentication and authorization) and WTRU configuration. The RM (for example, using CFM) may handle procedures for NAS modules life cycle management (configuration, activation, deactivation) as described below.

Embodiments and examples provided herein include activation and configuration of NAS modules. The activation and configuration of NAS modules may be within the WTRU. Additionally or alternatively, the activation and configuration of NAS modules may be within the network. the network may be the next generation of wireless systems, such as, for example, a Sixth Generation (6G) network.

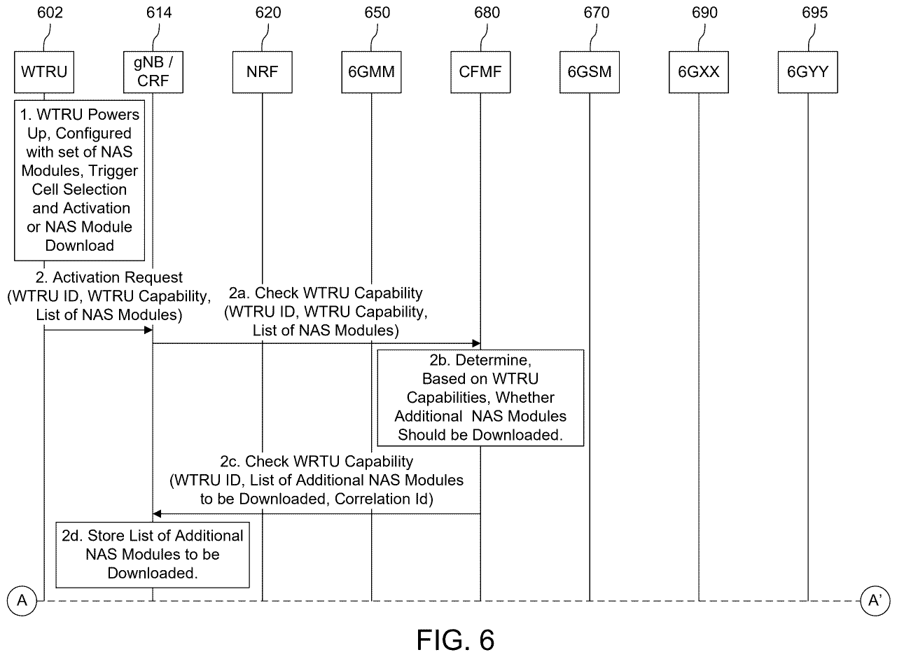

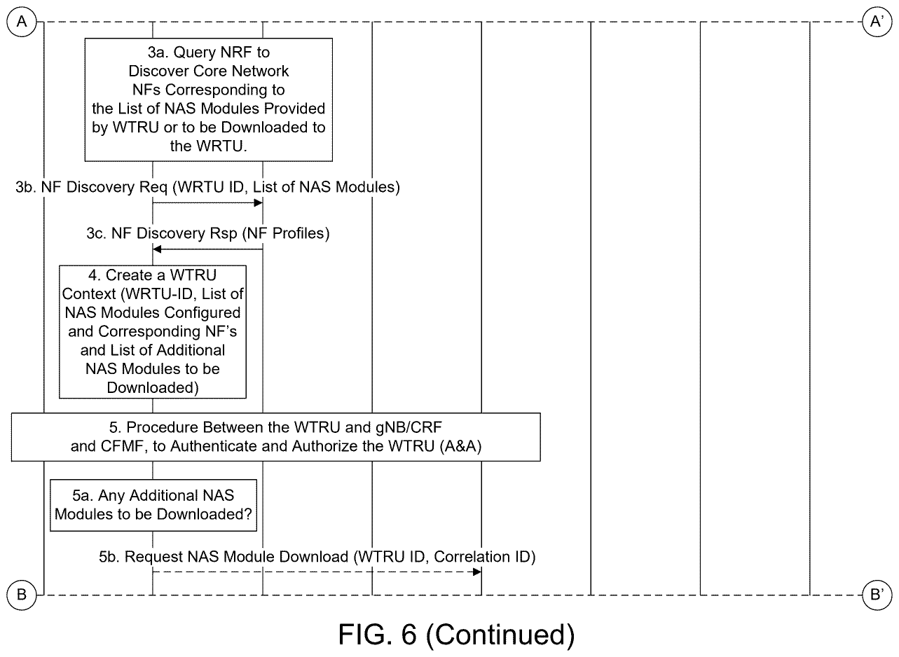

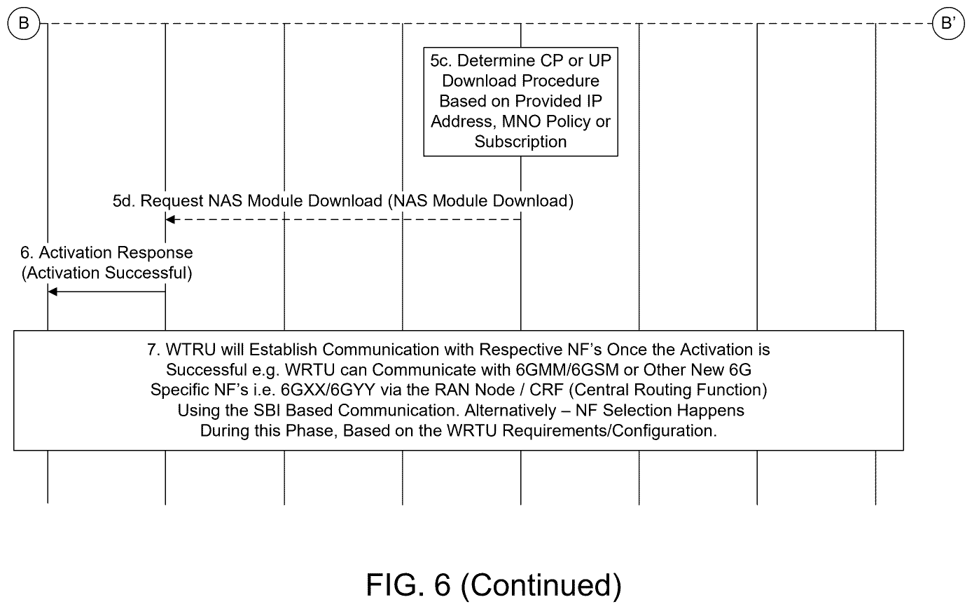

FIG. 6 is a signaling diagram illustrating an example of an activation and configuration of NAS modules. In an example shown in FIG. 6, a WTRU 602 may initiate the activation procedure based on different triggers (for example, at WTRU 602 boot up, after successful registration and/or upon reconfiguration of modular NAS functionality from the network).

In step 1, the WTRU 602 which supports the NAS modular design is powered on. The upper layers, GUI or other stored configuration within the WTRU 602 would provide the list of NAS functional modules which are enabled for the WTRU 602. In an example scenario, one or more modules could be set as default based on WTRU subscription or capabilities (for example, a preferred WTRU type). In an example scenario, based on the trigger, such as reading system broadcast information (such as a system information block (SIB)), previous communication with the core network function (for example registration or session management procedure), could lead to the WTRU 602 downloading/enabling the required set of NAS functional modules. This configuration could be provided by the application function (AF) via the IP connectivity to the WTRU 602, or this information is configured via the OTT means by the operator or administrator of the WTRU 602.

The WTRU 602, once powered on, would try to find and camp on a cell, and establish the radio connection with a RAN node 614. The RAN node 614 may be one or more of a CRF, base station, gNB, next generation of the gNB, gNB for 6G wireless networks, and the like. Further, the CRF functionality described herein may be implemented either independently, as a new NF, or integrated with the RAN node, an AMF or both. The establishment of the radio connection is not shown in FIG. 6. The radio communication between the WTRU 602 and the RAN node 614 could include security establishment, using existing 5G mechanisms to establish secure RRC layer communication, acting as a secure transport layer to carry upper layer (NAS) messages between the WTRU 602 and the RAN node 614, CRF, or both.

In step 2, once the WTRU 602 has established the radio connection with the RAN node 614, the WTRU 602 would send an Activation Message to the RAN node/CRF 614 along with the WTRU identifier, WTRU capabilities (voice or data, AIML support, sensing or location services support) and an information element containing a list of NAS modules enabled in the WTRU 602. The new functional block, in other words CRF (Central Routing Function), could be collocated within the RAN node 614, implemented as an additional functionality in other network functions, for example, an AMF, or implemented as a standalone network function. The communication between the network nodes would be based on service based architecture (SBA) using for example HTTP/2 APIs. In the scenario where the CRF is not collocated with the RAN node 614, in other words the base station, the base station will act as a bridge between the WTRU 602 and the CRF, and carry out the messages between the WTRU 602 and CRF. In this scenario, the CRF would be the node which will communicate with other core network functions (NFs), such as, for example SMF/NRF/PCF/UDM and so forth. In the following, it may be assumed that the base station/CRF are collocated as an example. However the procedures described herein are applicable for the other cases as well; for example, wherein the CRF is a separate entity or an extension of another network function.

In step 2a, the base station/CRF, on reception of the Activation message, may check with a CFMF 680, for example, based on the WTRU capability compared with the list of NAS modules, to determine whether additional NAS modules are required.

In step 2b, the CFMF 680 determines, for example, based on the WTRU capabilities and current NAS module list in the WTRU 602, whether additional NAS modules are required.

In step 2c, the CFMF 680 informs the CRF 614 about any additional NAS modules to be downloaded, and the CFMF 680 provides a download correlation ID for further use. This download correlation ID will be used by the CFMF 680 to identify the list of additional NAS modules to be downloaded for the WTRU. Additionally or alternatively, the CFMF 680 could execute both the NF discovery procedure, such as via an NRF 620, and the authentication procedure, and simply send an activation confirmation to the CRF 614 with the additional NAS modules to be downloaded.

In step 2d, the CRF 614 temporarily stores the correlation ID and the list of NAS modules to be downloaded, to be used during the authentication procedure.

In step 3 (a, b, c), the CRF 614 queries the NRF 620 to discover the corresponding NFs based on the list of NAS functional modules which have been enabled in the WTRU 602 and provided by the WTRU 602 in the activation message as part of the new information element containing the list of NAS modules, and/or the list of NAS modules to be downloaded provided by the CFMF 680. The base station/CRF 614 will trigger the query request/response with the NRF 620 to discover the NFs corresponding to the list of NAS modules. For example, the base station/CRF 614 may provide the WTRU identifier along with the information element containing list of NAS modules to the NRF 620 in an NF discovery request. As a result, the base station/CRF 614 may receive an NF discovery response, from the NRF 620.

In step 4, the base station/CRF 614 would create a WTRU context which will contain information such as, for example, a WTRU identifier, list of NAS modules configured, corresponding NFs (address information FQDN/IP Address), and the like.

In step 5, the base station/CRF 614 might trigger an authentication and authorization (A&A) process to ensure that the WTRU 602 is authorized for access to the requested network functions and corresponding functionality. For example, if the list of NAS modules provided by the WTRU 602, and/or the list of NAS modules to be downloaded provided by the CFMF 680, has session management (SM) functionality enabled, the base station/CRF 614 may trigger the A&A process between the WTRU 602 and corresponding NF to ensure that the WTRU 602 is an authorized WTRU to access the services provided by the network function. This A&A process could be the existing mechanism being used in the 5G system such as secondary authentication involving an external AAA server or this A&A process could be a mutual authentication between the WTRU and the corresponding NFs. If the base station/CRF 614 decided to carry out the A&A process, the WTRU context, which was created in step 5, would be updated after the successful A&A procedure. In case the A&A process is not successful, the WTRU 602 might be indicated the same, which might result in the requested services being not enabled for the WTRU 602.

In step 5a, the base station/CRF 614 determines whether additional NAS modules need to be downloaded, based on the information received from the CFMF 680 in Step 2c.

In step 5b, the base station/CRF 614 request from the CFMF 680 a download of NAS modules. For example, the base station/CRF 614 may send a Request message to the CFMF 680 providing the correlation ID and WTRU ID, and possibly a WTRU IP address if the download is to be done via the UP. The CFMF 680 will use the correlation ID to determine the list of NAS modules to be downloaded for the WTRU.

In a step 5c, the CFMF 680 determines whether the download will happen based on the WTRU's IP address, MNO polices and UDM subscription.

In a step 5d, the CFMF 680 downloads the additional NAS modules to the WTRU, for example, via control plane (CP) NAS DL TRANSPORT message or via the user plane (UP) towards the WTRU IP address provided by the CRF 614 in step 5b. Additionally or alternatively, the base station 614 assists in downloading the additional NAS modules to the WTRU. Additionally or alternatively, the WTRU 602 downloads the additional NAS modules from the CFMF 680.

In a step 6, the base station/CRF 614 sends an Activation response back to the WTRU 602 indicating success. The success indication means the requested NAS functional modules have been accepted by the network and corresponding services are enabled/available for the WTRU 602 to access. The base station/CRF 614 might provide an additional identifier (for example base station/CRF Identity) along with the activation response message. This identifier will identify the instance of the base station/CRF 614 which holds the context information of the WTRU 602. In case the WTRU 602 moves to a different location (power cycle, recovery from out of coverage or based on other scenarios) while triggering activation or re-activation procedure with the new base station/CRF 614, the WTRU 602 will include the identifier (in other words, the base station/CRF Identity) in the initial message (activation or re-activation message) which will enable the network entities, for example, the base station/CRF 614, to pull out the context information for the WTRU 602 from the last network node. The last network node may be the base station/CRF 614 which carried successful activation for the WTRU 602, and has stored WTRU context information.

In a step 7, once the WTRU 602 has been indicated successful activation of the functional blocks (NAS Modules) by the network, the WTRU 602 may use communication service via the respective NFs. For example, now the WTRU 602 can send a request for a PDU session setup to a 6GSM 670 (Session Management), or a new set of 6G network functions, such as 6GXX 690/6GYY 695, via the base station/CRF 614 using the SBI based communication. Additionally or alternatively, the WTRU 602 may now communicate with a 6GMM 650 using the SBI based communication.

Additionally or alternatively, during the unmodified activation process, the WTRU is typically merely enabled to access NFs. However, in examples of the modified activation process provided herein, the actual selection of the instance of the NF could be carried out in this step, where the selection of the NF entity can be dependent on many factors, such as, for example, local configuration in the CRF 614, UDM/Subscription information for the WTRU 602, slice requirements (S-NSSAI), DNN, requested services (for example, QoS differentiation for devices connected behind the WTRU 602, voice services, voice over 6G, and so forth), the WTRU's location information, and network conditions (NF load and availability).

The activation procedure above may be initiated as part of a Registration procedure or as a standalone procedure (for example, after successful registration). The configuration of modular NAS may be provided by the network to the WTRU 602 using a UE configuration update command (UCU) procedure. The modular NAS handling functionality in the Core Network may be realized in a dedicated NF (for example, CFMF, possibly co-located with a registration management function (RMF), access and mobility management function (AMF), and the like), which performs steps similar to the base station/CRF 614 above for NAS module configuration and activation. The WTRU A&A may take place prior to step 3 (for example, before step 2 of a standalone activation procedure) for the CFMF 680 to verify that the WTRU 602 is authorized for modular NAS configuration and activation (for example, based on subscription data, operator policy, and so forth). For example, in step 3, the CFMF 680 may verify that the NAS modules/function the WTRU 602 requests to use are authorized based on the data from a UDM/unified data repository (UDR).

In an example, a WTRU enables one or more NAS modules based on a WTRU configuration and one or more WTRU capabilities. The WTRU transmits an activation request message, including a WTRU ID for the WTRU, the one or more WTRU capabilities and a list of the one or more NAS modules enabled in the WTRU. Additionally or alternatively, a base station receives activation request message. Additionally or alternatively, the base station transmits, to an NF, a check WTRU capability request message including the WTRU ID for the WTRU, the one or more WTRU capabilities, and the list of the one or more NAS modules enabled in the WTRU. Additionally or alternatively, the base station receives, from the NF, a check WTRU capability response message including the WTRU ID for the WTRU, a list of additional NAS modules to download, and a correlation ID.

Further, the WTRU downloads at least one additional NAS module. Also, the WTRU receives an activation response message, including information indicating that activation of the one or more NAS modules is successful, and that activation of the at least one additional NAS module is successful. Additionally or alternatively, the activation response message is transmitted from the base station. Moreover, the WTRU transmits, based on the activation of the one or more NAS modules, one or more messages using the one or more NAS modules, or the at least one additional NAS module. Additionally or alternatively, the base station receives the one or more messages using the one or more NAS modules, or the at least one additional NAS module.

Additionally or alternatively, the one or more messages are transmitted using an SBI. Additionally or alternatively, the one or more NAS modules are enabled based on one or more of: GUI inputs; previous communication with core network functions; configuration information provided by an application function; configuration information provided by an operator or an administrator of the WTRU via OTT means; the WTRU configuration, wherein the WTRU configuration is stored; or the one or more WTRU capabilities.

Additionally or alternatively, the one or more NAS modules include one or more of: an RM module, an MM module, an SM module, or an LOC module. Additionally or alternatively, the WTRU downloads the one or more NAS modules from a CFMF, transmits the activation request message to a CRF, and receives the activation response message from the CRF.

Additionally or alternatively, the WTRU communicates with one or more of: a 6GMM function, a 6GSM function, or another 6G NF. Additionally or alternatively, the base station is a CRF. Additionally or alternatively, the base station communicates with one or more of: a 6GMM function, a 6GSM function, or another 6G NF.

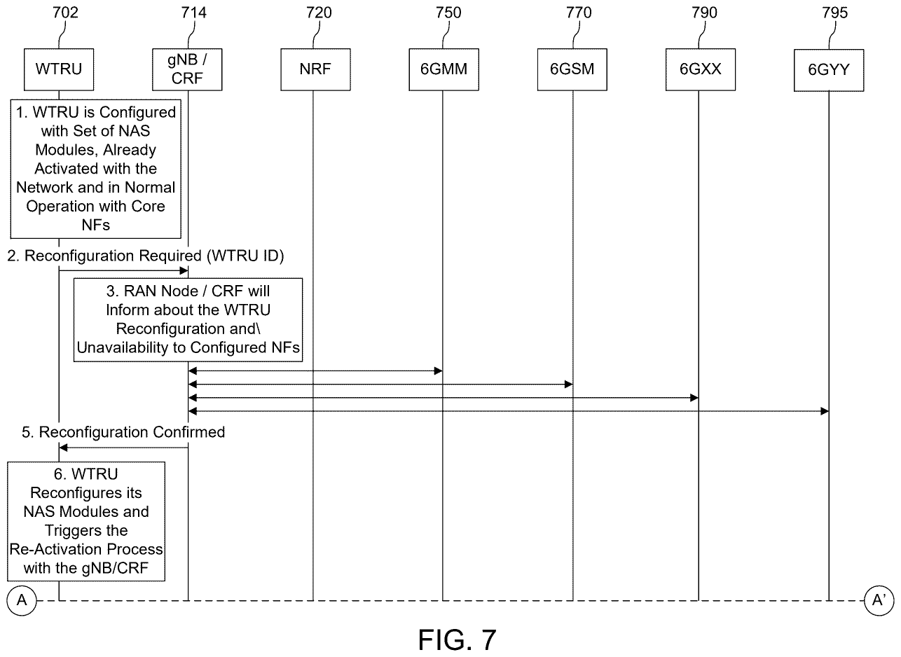

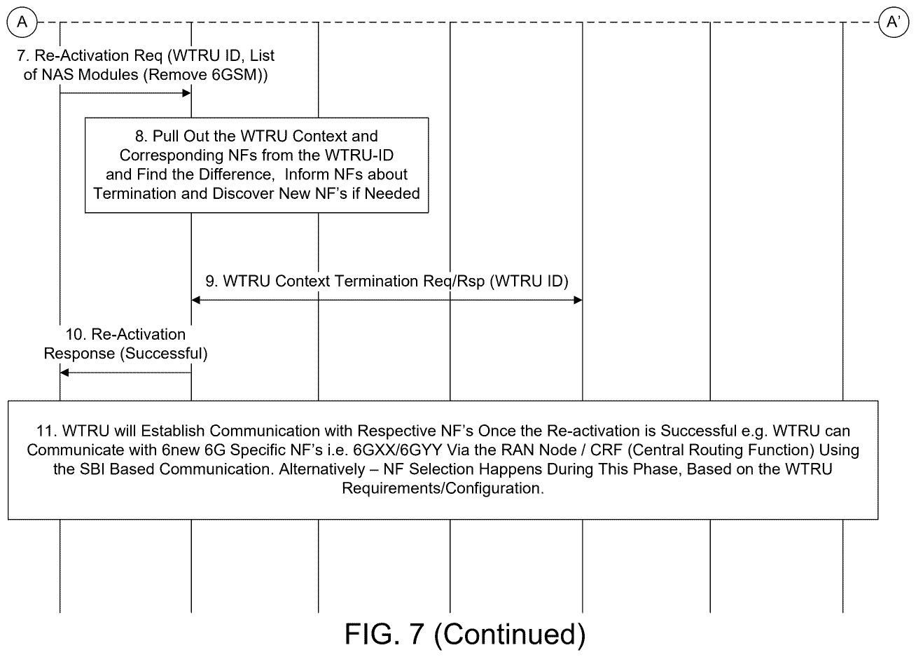

FIG. 7 is a signaling diagram illustrating an example of a reconfiguration of NAS modules. In a step 1 in an example in FIG. 7, a WTRU 702 is configured with a set of NAS functional modules, already activated with the network and WTRU 702 is successfully communicating with the corresponding network functions. For example, the WTRU 702 may have enacted one or more procedure provided in FIG. 6 and related text.

In a step 2, based on the trigger to update the configured NAS modules within the WTRU 702, in other words to add/remove NAS functional modules, the WTRU 702 sends a Reconfiguration Required message along with the WTRU identifier to a base station/CRF 714. The trigger to update the configuration of the NAS modules within the WTRU 702 could come from various sources, for example, from upper layers, from a GUI, trigger linked with time or location enabling/disabling certain NAS functionalities, from the application function (AF) via the IP connectivity to the WTRU 702, configured via the OTT means by the operator or administrator of the WTRU 702.

In a step 3, the base station/CRF 714, on reception of the reconfiguration required message from the WTRU 702, will pull the information about the configured NFs from the stored WTRU context and inform all configured NFs about the WTRU 702 unavailability due to reconfiguration of NAS functional modules. The configured NFs may include one or more of a 6GMM 750, a 6GSM 770, a 6GXX 790, or a 6GYY 795.

In a step 4, the base station/CRF 714 will indicate all configured NFs about the WTRU's unavailability due to reconfiguration via one or more WTRU Unavailability Request/Response messages, including the WTRU identifier and reconfiguration as the reason for WTRU being unavailable. The NFs, based on their local configuration/implementation, would either discard or buffer the downlink traffic for the WTRU 702. If an application function or other network function has subscribed to the availability of the WTRU 702, the NF would indicate unavailability of the WTRU 702.

In a step 5, the base station/CRF 714 would indicate the Reconfiguration Confirmed to the WTRU 702, once it has received response from all configured NFs.

In a step 6, the WTRU 702, on reception of the reconfiguration confirmed message, would reconfigure the NAS modules. In other words, the WTRU 702 may add/remove NAS modules and trigger the re-activation process with the base station/CRF 714.

In a step 7, the WTRU 702 sends the re-activation request to the base station/CRF 714. The re-activation message or re-activation request message is similar to the known activation message, with a difference that re-activation request message described in examples herein is sent by the WTRU 702 when it has already been activated with the network before. In other words, the base station/CRF 714 already has WTRU context and list of configured NAS modules and corresponding NFs at this step, in an example.

In a step 8, the base station/CRF 714, on the reception of the re-activation request message from the WTRU 702, pulls out the WTRU context information and determines the difference between the newly requested list of NAS modules and already configured NAS modules as per the WTRU stored context. The base station/CRF 714 will determine the difference for the corresponding NFs from the newly requested/reactivated NAS modules, will indicate termination to the NFs which are no longer needed, discover and add new NFs (FQDN/IP Address), may communicate with the NRF 720, and indicate availability back again for the NFs which have no change.

In a step 9, the base station/CRF 714 will indicate WTRU context termination request/response to the NFs which are no longer needed. For example, the message would carry the WTRU identifier as a parameter. The NFs will discard any stored/buffered DL data for the WTRU 702. In an example, the base station/CRF 714 will indicate WTRU context termination request/response to the 6GSM 750.

In a step 10, the base station/CRF 714 will indicate re-activation response to the WTRU 702 with success, once the base station/CRF 714 has been successful in terminating NFs which are no longer needed, discovering new NFs (FQDN/IP Address) and indicating availability back online for the existing NFs which are still maintained.

In a step 11, once the WTRU 702 has been indicated successful re-activation of the functional blocks (NAS Modules) by the network, the WTRU 702 will establish communication with the respective NFs. For example, now the WTRU 702 may communicate with the 6GSM 750 (Session Management), or a new set of 6G network functions, such as 6GXX 790/6GYY 795 via the base station/CRF 714 using SBI based communication.

Additionally or alternatively, during the unmodified re-activation process, the WTRU is typically merely enabled to access NFs. However, in examples of the modified re-activation process provided herein, the actual selection of the instance of the NF could be carried out in this step, where the selection of the NF entity can be dependent on many factors, such as, for example, local configuration in the CRF 714, UDM/Subscription information for the WTRU 702, slice requirements (S-NSSAI), DNN, requested services (for example, QoS differentiation for devices connected behind the WTRU, voice services, voice over 6G, and so forth), the WTRU's location information, and network conditions (NF load and availability).

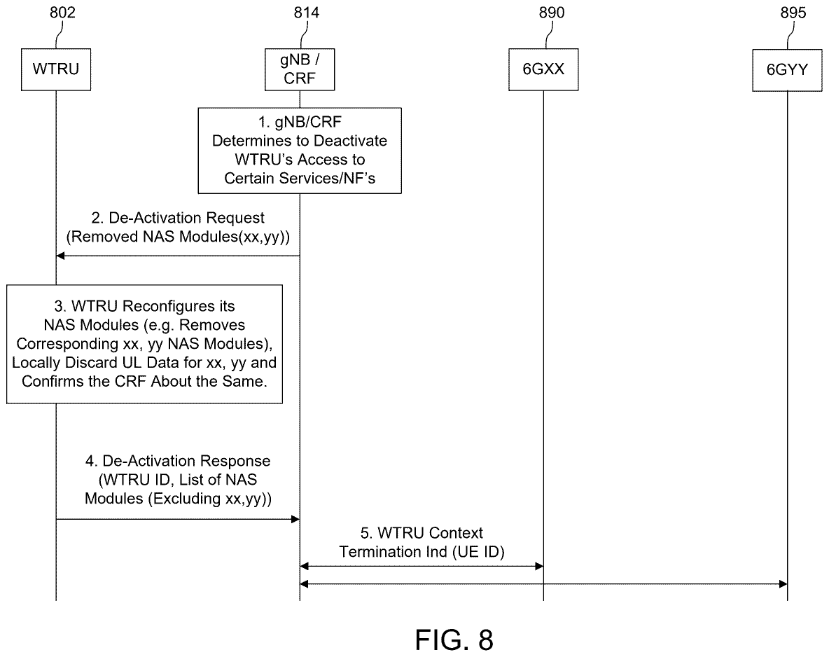

FIG. 8 is a signaling diagram illustrating an example of network initiated deactivation of NAS modules. As shown in an example in FIG. 8, a base station/CRF 814 determines to deactivate access of a WTRU 802 to certain services/NFs in a step 1. The trigger for network-initiated deactivation of NAS functional modules could be based on various factors, for example, Policy based (for example, inputs from the predictive analytics, AIML modeling, Energy efficiency and so forth), WTRU usage based (inactivity or services being not used for a while), subscription (location/time), network conditions (congestion), input from the AF, and so forth.

In a step 2, the base station/CRF 814 sends the De-Activation request message to the WTRU 802 along with the list of NAS modules and corresponding network functions which have been removed. For example, 6Gxx 890 and 6Gyy 895 have been removed for the WTRU 802. The base station/CRF 814 would update the WTRU context to reflect this information.

In a step 3, the WTRU 802, on reception of the De-Activation request message, reconfigures the NAS modules, removes the NAS Modules corresponding to the list of NAS Modules/NFs provided by the base station/CRF 814, and locally discards the UL Data/pending data for the removed NAS modules, for example, for an xx NAS Module and a yy NAS Module.

In a step 4, the WTRU 802 responds to the base station/CRF 814 with the deactivation response, including the WTRU identifier and updated list of NAS modules excluding the ones which have been indicated as removed by the network, in other words, the base station/CRF 814.

In a step 5, the base station/CRF 814, on reception of the De-activation response from the WTRU 802, indicates regarding the WTRU context termination to respective NFs which have been removed for the WTRU 802. The response may include a WTRU identifier as a parameter to the message, in an example. The respective NFs which have been removed for the WTRU 802 may include one or more of the 6Gxx 890 and the 6Gyy 895.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
enabling one or more non-access stratum (NAS) modules based on a WTRU configuration and one or more WTRU capabilities;
transmitting an activation request message, including a WTRU identifier (ID) for the WTRU, the one or more WTRU capabilities and a list of the one or more NAS modules enabled in the WTRU;
downloading at least one additional NAS module;
receiving an activation response message, including information indicating that activation of the one or more NAS modules is successful, and that activation of the at least one additional NAS module is successful; and
transmitting, based on the activation of the one or more NAS modules, one or more messages using the one or more NAS modules, or the at least one additional NAS module.

2. The method of claim 1, wherein the one or more messages are transmitted using a service based interface (SBI).

3. The method of claim 1, wherein the one or more NAS modules are enabled based on one or more of: graphical user interface (GUI) inputs; previous communication with core network functions; configuration information provided by an application function; configuration information provided by an operator or an administrator of the WTRU via over-the-top (OTT) means; the WTRU configuration, wherein the WTRU configuration is stored; or the one or more WTRU capabilities.

4. The method of claim 1, wherein the one or more NAS modules include one or more of: a registration management (RM) module, a mobility management (MM) module, a session management (SM) module, or a location services (LOC) module.

5. The method of claim 1, wherein the WTRU downloads the one or more NAS modules from a configuration management function (CFMF), transmits the activation request message to a central routing function (CRF), and receives the activation response message from the CRF.

6. The method of claim 1, wherein the WTRU communicates with one or more of: a Sixth Generation (6G) mobility management (6GMM) function, a 6G session management (6GSM) function, or another 6G network function (NF).

7. A wireless transmit/receive unit (WTRU) comprising:
a processor; and
a transceiver operatively coupled to the processor; wherein:
the processor is configured to enable one or more non-access stratum (NAS) modules based on a WTRU configuration and one or more WTRU capabilities;
the processor and the transceiver are configured to transmit an activation request message, including a WTRU identifier (ID) for the WTRU, the one or more WTRU capabilities and a list of the one or more NAS modules enabled in the WTRU;
the processor and the transceiver are configured to download at least one additional NAS module;
the processor and the transceiver are configured to receive an activation response message, including information indicating that activation of the one or more NAS modules is successful, and that activation of the at least one additional NAS module is successful; and
the processor and the transceiver are configured to transmit, based on the activation of the one or more NAS modules, one or more messages using the one or more NAS modules, or the at least one additional NAS module.

8. The WTRU of claim 7, wherein the one or more messages are transmitted using a service based interface (SBI).

9. The WTRU of claim 7, wherein the one or more NAS modules are enabled based on one or more of: graphical user interface (GUI) inputs; previous communication with core network functions; configuration information provided by an application function; configuration information provided by an operator or an administrator of the WTRU via over-the-top (OTT) means; the WTRU configuration, wherein the WTRU configuration is stored; or the one or more WTRU capabilities.

10. The WTRU of claim 7, wherein the one or more NAS modules include one or more of: a registration management (RM) module, a mobility management (MM) module, a session management (SM) module, or a location services (LOC) module.

11. The WTRU of claim 7, wherein the WTRU downloads the one or more NAS modules from a configuration management function (CFMF), transmits the activation request message to a central routing function (CRF), and receives the activation response message from the CRF.

12. The WTRU of claim 7, wherein the WTRU communicates with one or more of: a Sixth Generation (6G) mobility management (6GMM) function, a 6G session management (6GSM) function, or another 6G network function (NF).

13. A base station comprising:
a processor; and
a transceiver operatively coupled to the processor; wherein:
the processor and the transceiver are configured to receive, from a WTRU, an activation request message, including a WTRU identifier (ID) for the WTRU, one or more WTRU capabilities and a list of one or more non-access stratum (NAS) modules enabled in the WTRU;
the processor and the transceiver are configured to transmit, to a network function (NF), a check WTRU capability request message including the WTRU ID for the WTRU, the one or more WTRU capabilities, and the list of the one or more NAS modules enabled in the WTRU;
the processor and the transceiver are configured to receive, from the NF, a check WTRU capability response message including the WTRU ID for the WTRU, a list of additional NAS modules to download, and a correlation ID;
the processor and the transceiver are configured to transmit, to the WTRU, an activation response message, including information indicating that activation of the one or more NAS modules is successful, and that activation of at least one NAS module, of the list of additional NAS modules to download, is successful; and
the processor and the transceiver are configured to receive, from a WTRU, one or more messages using the one or more NAS modules, or the at least one NAS module.

14. The base station of claim 13, wherein the base station is a central routing function (CRF).

15. The base station of claim 13, wherein the NF is a configuration management function (CFMF).

16. The base station of claim 13, wherein the one or more messages are transmitted using a service based interface (SBI).

17. The base station of claim 13, wherein the one or more NAS modules include one or more of: a registration management (RM) module, a mobility management (MM) module, a session management (SM) module, or a location services (LOC) module.

18. The base station of claim 13, wherein the base station communicates with one or more of: a Sixth Generation (6G) mobility management (6GMM) function, a 6G session management (6GSM) function, or another 6G NF.
